(19) United States
(12) Patent Application Publication
(10) Pub. No.: US 2003/0144039 A1
(43) Pub. Date: Jul. 31, 2003

(54) Communication cord pathway concealed clothes

(76) Inventor: Yung Fang Lin, Taipei (TW)

Correspondence Address: DOUGHERTY & TROXELL, ONE SKYLINE PLACE, SUITE 1404, 5205 LEESBURG PIKE, FALLS CHURCH, VA, 22041, US

(21) Appl. No.: 09/794,280

(22) Filed: Feb. 28, 2001

(51) Int. Cl. H04M 1/00

(52) U.S. Cl. 455/568; 455/66

(57) ABSTRACT

Communication cord pathway concealed clothes conceals a communication pathway along a sleeve or other seamed edges of clothes with both ends opened near the use's ear side and pocket where an earphone and a microphone is connected to the upper end of a communication cord laid in the pathway; while a cellular phone of various brands or other electronic device is connected to the lower end of said cord thereby forming a communication circuit. The user may use the cellular phone or the like conveniently and securely without the fear of the cord to twine around things nearby causing the cellular phone to drop down on the ground.

### BACKGROUND OF THE INVENTION

1. Field of the Invention

The present invention relates to communication cord pathway concealed clothes, and more particularly, to clothes concealing a communication cord pathway along a sleeve or other seamed edges of clothes with both ends opened near the user's ear side and pocket where an earphone, a microphone, and a cellular phone of various brands or other miniature electronic device are connected to a communication cord laid in the concealed pathway.

2. Description of the Prior Art

In keeping pace with rapid development of electronic communication technique, cellular phones and other portable miniature electronic devices are widely in use all over the world. Pedestrians walking along the street or people driving their cars while using their cellular phones with one hand to cause traffic accidents becomes an astonishing scene in every country. In recent years, a hand free cellular phone kit has been developed as a solution to overcome inconvenience for using a common cellular phone in the car. In this equipment, a stationary base in connection with the car power supply source and the antenna through a plurality of communication cords is mounted nearby the driver's seat so as to use the cellular telephone hand freely with widened sensitivity range. However, in order to accommodate such a kit in the car, the inherent interior arrangement in the car has to be somewhat changed resulting in a new difficulty in rearranging car interior articles or equipment and adding an extra cost. Besides, the hand free cellular phone kit can solve the problem of using a cellular phone in the car, but it is no help to pedestrians who are eagerly wanting a lighter, thinner, and shorter sized hand free cellular phone convenient to use and carry with as well.

FIG. 1 shows a drawing wherein a lady is carrying with her a hand free cellular phone. As shown in FIG. 1, the kit has an earphone 10 to receive a voice signal from the cellular phone body 12, and the user talks to a microphone 11. Meanwhile, there is a problem that there is a phone cord 13 hanging between the earphone 10 and the cellular phone body 12. This cord 13 is apt to meander and twine around any other things existing nearby when being carried around with the user, and worse to worst, it might cause the cellular phone to drop down on the ground.

Therefore, an invention devoting to resolving aforesaid disadvantages of current problem about the cellular phone is definitely necessary. The present inventor has delved into this matter with a long time efforts and come to realization of the present invention.

### SUMMARY OF THE INVENTION

It is an object of the present invention to provide communication cord pathway concealed clothes in which a concealed communication pathway is formed in the inner side of selected parts of clothes along for example, the seamed edge of a sleeve, or the side edge of a coat, one end of the pathway has an exit near the user's ear. The communication cord is conveniently laid along the pathway without affecting the user's movement or spoiling the appearance of the user's clothes, and it is preferably to form the pathway as stably in the inner side of the user's clothing as possible so that obstructiveness to the user's movement such as taking out something out of the pocket can be minimized.

It is another object of the present invention to provide a communication cord pathway concealed clothes with which the user can effectively use the cellular phone of various brands for communication even his/her both hands are busy.

For fuller understanding of the nature and objects of the invention reference should be made to the following detailed description taken in conjunction with the accompanying drawings.

### BRIEF DESCRIPTION OF THE DRAWINGS

FIG. 1 is a drawing wherein a lady is carrying with her a conventional hand free cellular phone;

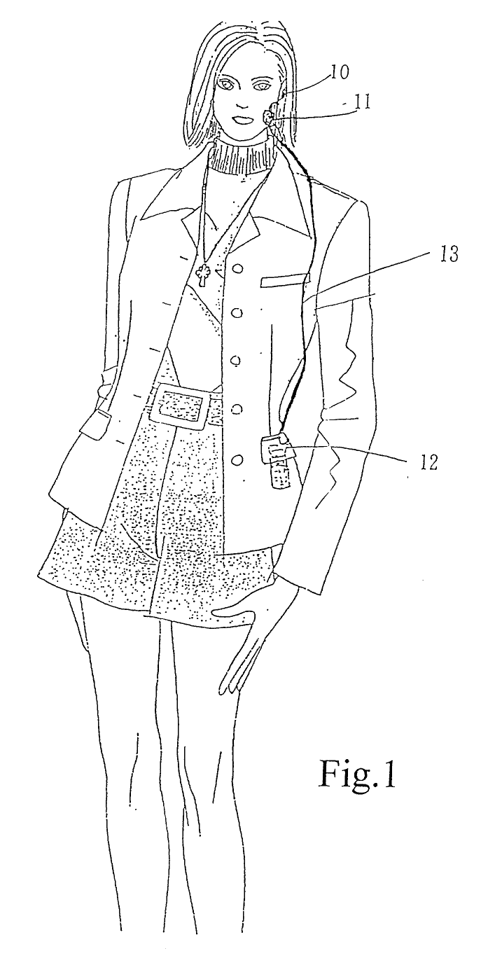

FIG. 2 is a perspective front view of an overcoat concealing a communication cord;

FIG. 3 is a schematic view of a communication cord disposed according to an embodiment of the present invention;

FIG. 4 is a schematic view in another embodiment of the present invention;

FIG. 5 is a perspective front view of a T shirt equipped with a concealed communication cord pathway according to the present invention;

FIG. 6 is a perspective front view of a vest equipped with a concealed communication cord pathway according to the present invention;

FIG. 7 is a perspective front view of a pantsuit equipped with a concealed communication cord pathway according to the present invention;

FIG. 8 is a perspective front view of an overcoat equipped with a concealed communication cord pathway according to the present invention;

FIG. 9 is a perspective front view of the coat of a two-piece suit equipped with a concealed communication cord pathway according to the present invention.

### DETAILED DESCRIPTION OF THE PREFERRED EMBODIMENTS

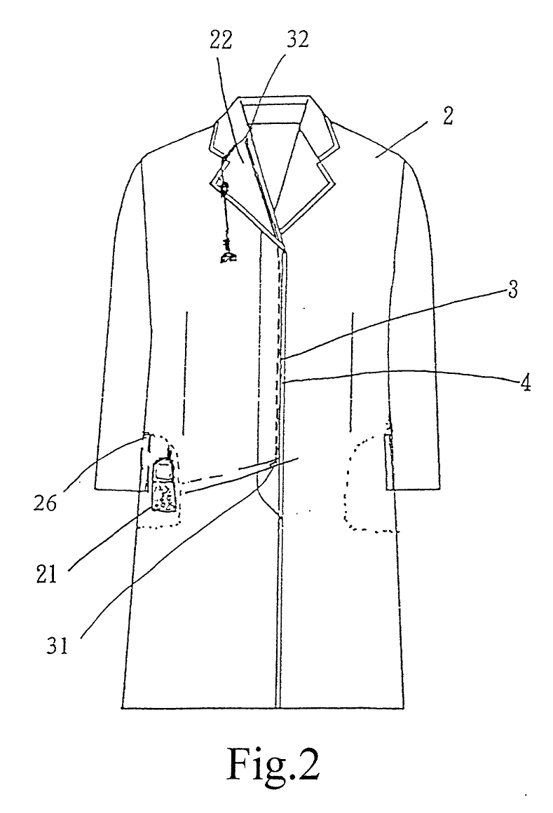

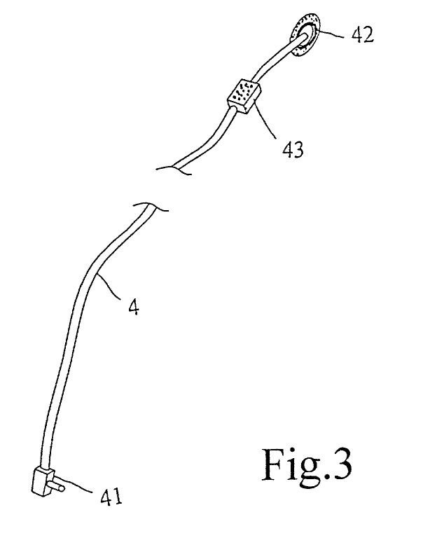

FIG. 2 is a perspective front view showing an overcoat is equipped with a concealed communication cord pathway. As shown in FIG. 2, a concealed pathway 3 is formed in the inner side of selected parts of an overcoat 2 along the seamed edge of a sleeve, or the side edge of the overcoat 2. Both end exits 31, 32 are respectively opened near at a pocket 21 where a cellular phone or other miniature electronic device is pocketed, and at a collar 22 or other upper position on the clothes nearby an user's ear. A communication cord 4 is laid along in the pathway 3. In an embodiment of the present invention shown in FIG. 3. An earphone 42 and a microphone 43 are directly formed on the cord 4 and a plug 41 to plug into terminal of the cellular phone or other electronic device for receiving and sending voice signals.

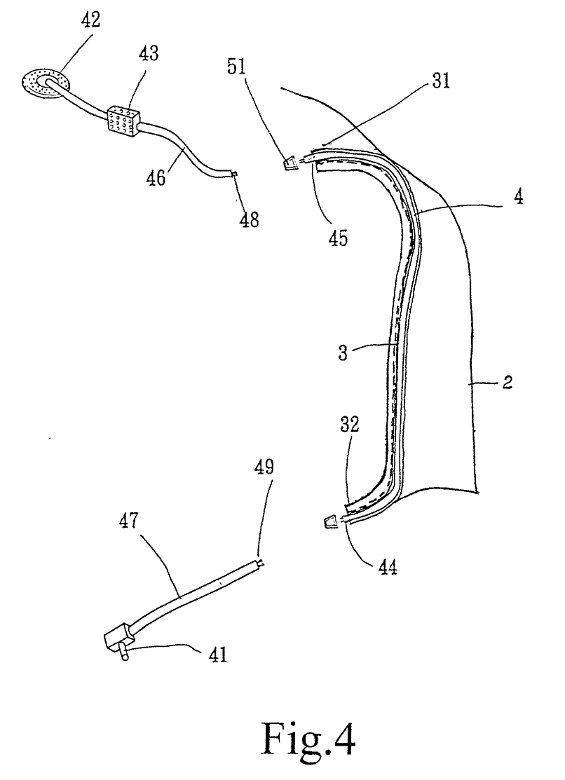

For another embodiment of the invention, reference should be made to FIG. 4 wherein the pathway 3 is formed by a sewing machine along the inner side of the sleeve or a side edge under the armpit of the overcoat or other clothing 2 near an arm where the user's movement is not affected. In order to keep the communication cord 4 clean and dry in cleansing the clothes 2, threaded portions 44 and 45 are formed at both ends of the cord 4 so that each end of the cord 4 can be sealed by a sealing screw cap 51 when cleansing the clothes 2 thereby keeping the cord 4 in a perfectly insulated situation. The plug 41 of a branch cord 47 for jointing to the cellular phone or other electronic device is disposed nearby the pocket 26 at the lower part of the clothing; the other branch cord 46 is directly in connection with the earphone 42 and microphone 43. The branch cords 46 and 47 are respectively connected to the threaded portions 44, 45 of the main communication cord 4 with terminal blocks 48 and 47 thereby completing an entire circuit of communication.

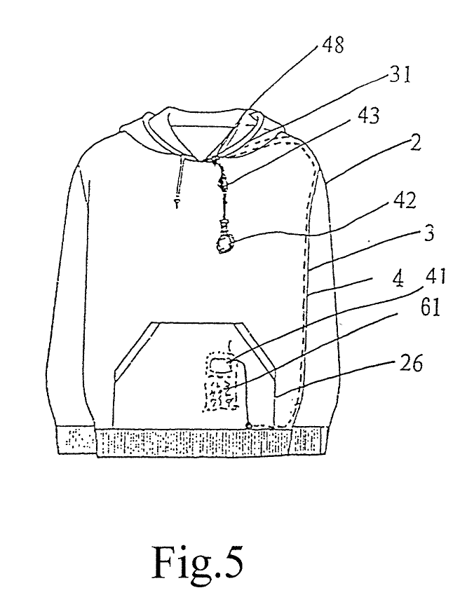

In applying the present invention to a T shirt 6, reference should be made to FIG. 5. As shown in FIG. 5, the exit 31 for the pathway 3 is formed at the position shaded by the collar 22. One end of the communication cord 4 is drawn out from this exit 31 and is connected to a receptacle terminal 48 of the earphone 42 and the microphone 43. On the other hand, the plug 41 of the communication cord 4 is inserted into the socket of a cellular phone 61 pocketed in the pocket 26 thereby completing an entire circuit of communication.

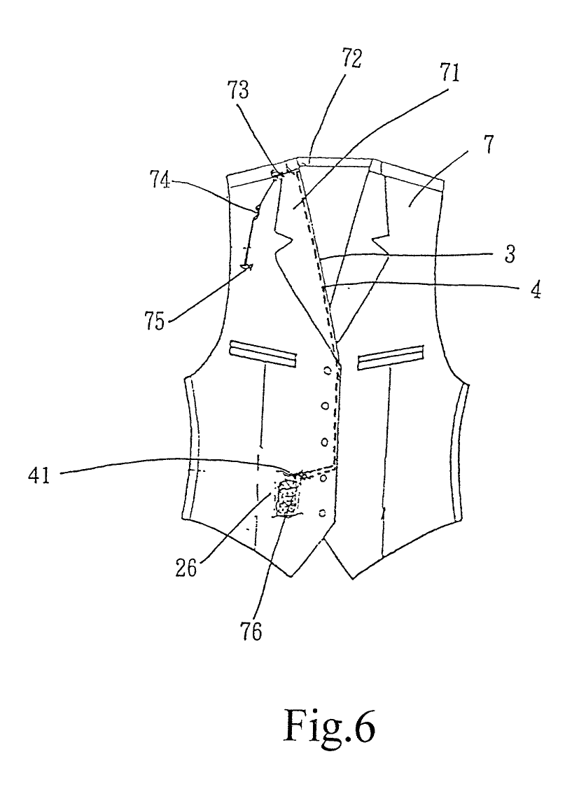

In applying the present invention to a vest 7, reference should be made to FIG. 6. As shown in FIG. 6, the pathway 3 is formed along inner edge 71 of the collar 72, and an exit is opened at an upper position of the collar 72 thereof whereat a receptacle terminal 73 of a microphone 74 and an earphone 75 is provided for connecting on end of the communication cord 4. The other end of the pathway 3 had an exit near the pocket 26 where the plug 41 formed at the other end of the cord 4 is plugged into cellular phone installed in a bag 76 hanging in the pocket 26 thereby completing an entire circuit of communication.

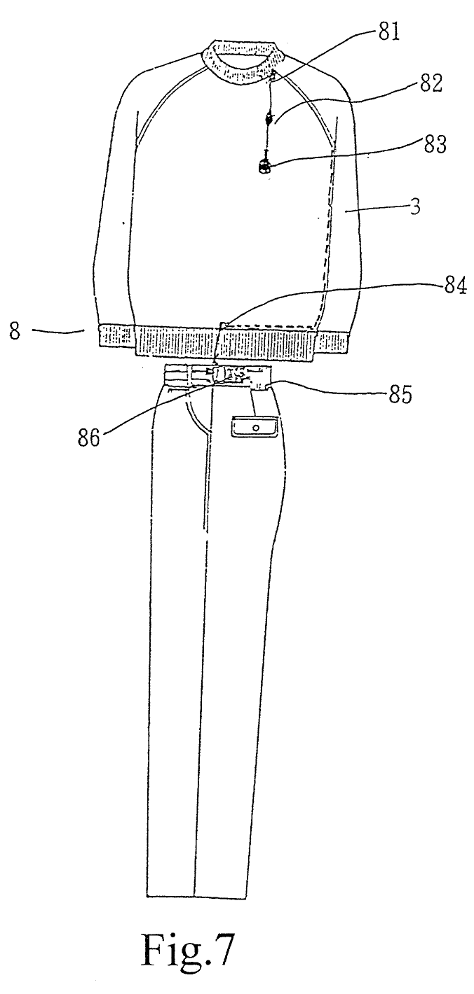

In applying the present invention to a pantsuit 8, reference should be made to FIG. 7. As shown in FIG. 7, the pathway 3 is formed along one side of the shoulder and the trunk directly under the armpit, then turns to the center of the lowermost position of the coat near the navel where an exit 84 is provided for the communication cord 4 stretching out to reach the cellular phone 86 or the like which is equipped at the waist 85 near the buckle of the user's band, and another exit 81 of the pathway formed at the upper part of the coat is for connecting the cord 4 to receptacle for an earphone 82 and a microphone 83 thereby completing an entire circuit of communication.

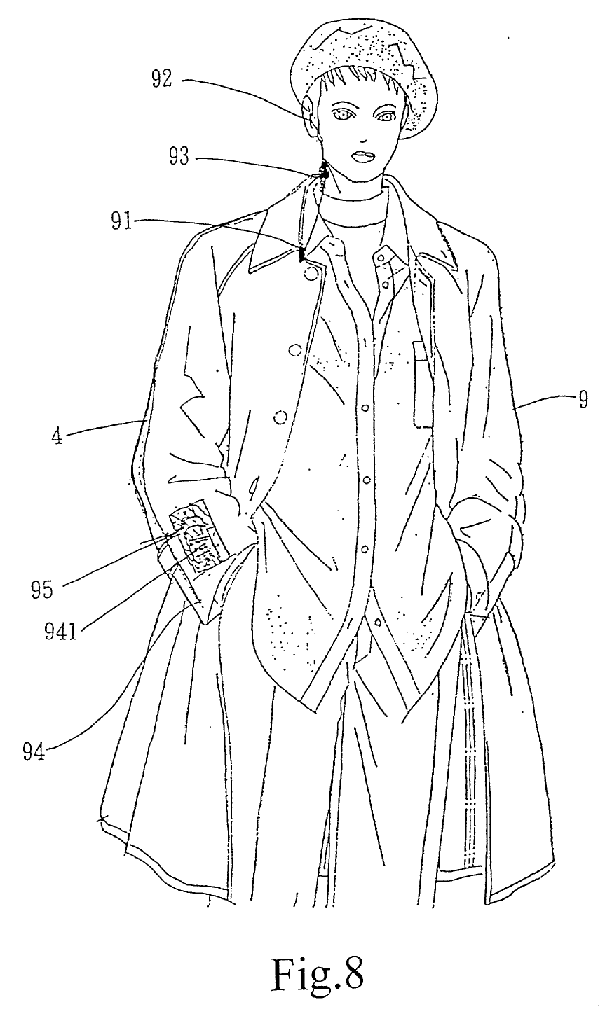

In applying the present invention to an overcoat 9, reference should be made to FIG. 8. As shown in FIG. 8, the communication cord 4 is laid in the pathway 3 which is formed along the outer side of one coat sleeve from the collar down to the opening 94 of the sleeve. The upper end of the cord 4 is plugged into a receptacle 91 of a microphone 92 and an earphone 93; on the other hand, the lower end of the cord 4 is plugged into a receptacle 95 for connecting to a cellular phone 941. With this construction, the user can use the cellular phone conveniently without worrying about twining the cord 4 around something.

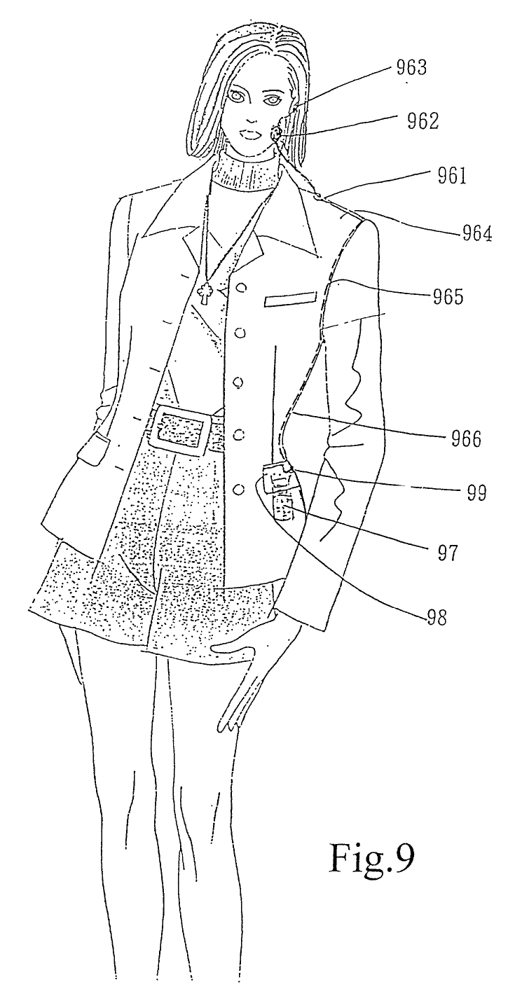

In applying the present invention to an overcoat 96 of the two-piece suit, reference should be made to FIG. 9. As shown in FIG. 9, the pathway 3 is formed from a position near the collar, along a shoulder portion 964, seam 965 between the coat 96 and its sleeve, waist 966, down to a position near a pocket 98. The upper end of the cord 4 is plugged into a receptacle 961 of a microphone 962 and an earphone 963; on the other hand, the lower end of the cord 4 is plugged into a receptacle 99 for connecting to a cellular phone 97 in a pocket 98 thereby completing an entire circuit of communication.

What is claimed is:

1. Communication cord pathway concealed clothes concealing a communication pathway along a sleeve or other seamed edges of clothes with an upper exit opened at the collar near the user's ear side and an lower exit opened near the pocket so that an earphone and a microphone being connected to the upper terminal of a communication cord laid in said pathway, while a cellular phone or other electronic device being connected to the lower terminal of said communication cord thereby forming a communication circuit.

2. The clothes of claim 1, wherein said pathway is formed [symbol] along inner part of said clothes with a sewing machine and is not affecting movement of the user.

3. The clothes of claim 2, wherein said communication cord is accommodated in said concealed pathway.

4. The clothes of claim 1, 2, or 3, wherein both terminals of said communication cord are threaded so as to screw unto respective screw caps thereby preventing entry of water into said communication cord.

5. The clothes of claim 1, 2, or 3, wherein one end of said communication cord is equipped with a plug for connecting to said earphone and said microphone, while the other end of said communication cord is also equipped with a plug for connecting to said cellular phone or other electronic device.

6. The clothes of claim 4, wherein one end of said communication cord is unseparately jointed to said microphone and said earphone; while the other end thereof is equipped with said plug to be plugged into an receptacle terminal of said cellular phone or other electronic device.
